(19) United States
(12) Patent Application Publication
(10) Pub. No.: US 2026/0356186 A1
(43) Pub. Date: Nov. 12, 2026

(54) Method for Controlling the Temperature of an Electric Drive Unit of a Motor Vehicle, in Particular a Car

(71) Applicant: Bayerische Motoren Werke Aktiengesellschaft, Muenchen (DE)

(72) Inventors: Toni BARTH, Muenchen (DE); Nikola BRK, Muenchen (DE)

(21) Appl. No.: 19/118,952

(22) PCT Filed: Nov. 9, 2023
(86) PCT No.: PCT/EP2023/081245

§ 371 Date: Apr. 7, 2025

(30) Foreign Application Priority Data
Dec. 6, 2022 (DE) 10 2022 132 340.4

(51) Int. Cl. B60K 11/02; B60K 1/00

(52) U.S. Cl. CPC B60K 11/02; B60K 2001/006

(57) ABSTRACT

A method for controlling the temperature of an electric drive unit of a motor vehicle comprising at least one electric machine, in which method a temperature-control medium is conveyed through a flow path by a pump, wherein the temperature of at least a partial region of the drive unit is controlled by the temperature-control medium, and wherein the pump can be operated at different operating points at different volume flows of the temperature-control medium. A heat exchanger is arranged in the flow path. An associated cooling value is calculated in each case for each operating point, and in each case characterizes a temperature of the sub-region that can be brought about by each operating point of the pump belonging to each cooling value. Depending on the calculated cooling values, one of the operating points is selected and the pump is operated at the selected operating point.

### BACKGROUND AND SUMMARY

The present disclosure relates to a method for controlling the temperature of an electric drive unit of a motor vehicle, in particular a car, i.e. for cooling and/or heating it.

US 2011/0214627 discloses a control device for a motor cooling system in which an electric pump is controlled in such a way that it circulates a coolant. CN102815222 B furthermore discloses a thermal management system of a vehicle.

An object of the present disclosure is to provide a method by which the temperature of an electric drive unit of a motor vehicle, in particular a car, can be controlled particularly effectively and particularly efficiently, i.e. it can be cooled and/or heated.

This object is achieved according to the present disclosure by a method having the features disclosed herein. Advantageous embodiments are also the subject of the present disclosure.

The present disclosure relates to a method for controlling the temperature of an electric drive unit, i.e. for cooling and/or heating it, said electric drive unit having at least one electric machine, of a motor vehicle, also referred to as a vehicle and preferably in the form of a car. This means that the motor vehicle has the electric drive unit, also referred to as a drive device, and thus the at least one electric machine, wherein the motor vehicle can be driven electrically, in particularly solely electrically, by the electric machine. It is in particular conceivable that, in the method, the electric machine drives the motor vehicle electrically, in particular solely electrically. The electric machine is preferably a high-voltage component with an electrical voltage, in particular electrical operating and nominal voltage, which is preferably greater than 50 volts, in particular greater than 60 volts, and is very preferably several hundred volts.

In the method, a temperature-control agent is conveyed through a flow path by a pump. The pump is operated for this purpose. In particular, the pump is an electric pump and therefore an electrically operatable pump. The temperature of at least a subarea of the drive unit, in particular the electric machine, is controlled, i.e. it is heated and/or cooled, by the temperature-control agent. If the temperature-control agent has a higher temperature than the subarea, the temperature-control agent is or functions as a heating medium by which at least the subarea of the drive unit is heated, in particular by heat being transmitted to the subarea of the machine from the temperature-control agent. If, for example, the temperature-control agent has a lower temperature than the subarea, the temperature-control agent is or functions as a coolant by which at least the subarea is cooled, in such a way that heat is transmitted to the temperature-control agent from the subarea.

The subarea of the drive unit can be or comprise the electric machine. In other words, the subarea can be at least a part of the electric machine or comprise at least a part of the electric machine. For example, the subarea can be or comprise at least a part or subarea of a stator and/or a rotor, in particular of a rotor shaft, of the electric machine. The electric machine is also referred to as an electric motor. Alternatively or additionally, the subarea can, for example, comprise at least a part or subarea of a component, provided in addition to the electric machine and in particular different from the electric machine, of the drive unit, or alternatively or additionally the subarea can, for example, be at least a part or subarea of a component, provided in addition to the electric machine and in particular different from the electric machine, of the drive unit. The component can have or comprise, for example, at least one inverter and/or one transmission.

The pump can be operated at different operating points with different volume flows of the temperature-control agent. In other words, the pump is designed to be operated at the said different operating points with the different volume flows. Put in still other words, the pump can be operated at the different operating points, wherein the operating points differ from one another in their respective volume flows effected by the pump or volume flows of the temperature-control agent which are effected by the conveying, which is or can be effected by the pump, of the temperature-control agent. The following is to be understood hereby: if the pump is operated at a first of the operating points, the pump conveys the temperature-control agent in such a way that the temperature-control agent has a first volume flow and therefore flows through the flow path with the first volume flow. If, for example, the pump is operated at a second of the operating points, the pump conveys the temperature-control agent in such a way that the temperature-control agent has a second volume flow which is different from the first volume flow and therefore flows through the flow path with the second volume flow which is different from the first volume flow. The respective volume flow corresponds to a respective mass flow of the temperature-control agent, in particular because the respective mass flow results from the respective volume flow multiplied by the density of the temperature-control agent. The respective volume flow is thus to be understood as a respective mass flow of the temperature-control agent, or the respective volume flow can be equated with a respective mass flow of the temperature-control agent.

In the method, arranged in the flow path is a heat exchanger which is arranged, in the direction of flow of the temperature-control agent conveyed by the pump and consequently flowing in a direction of flow through the flow path and hence through the heat exchanger, upstream of the subarea, in particular upstream of the electric machine. In particular, the heat exchanger is arranged downstream of the pump in the flow path. In the method, the temperature-control agent conveyed by the pump and consequently flowing through the flow path, and a further fluid which is different in particular from the temperature-control agent, flow through the heat exchanger. In particular, the temperature-control agent is a first fluid, wherein the further fluid is a second fluid which is in particular different from the first fluid.

Heat is exchanged between the temperature-control agent and the fluid via the heat exchanger, as a result of which the temperature of the temperature-control agent is controlled, i.e. it is cooled and/or heated, in particular upstream of the subarea of the drive unit. In other words, because heat is exchanged between the temperature-control agent and the fluid via the heat exchanger, the temperature of the temperature-control agent is controlled on its course through the flow path and hence from the pump to the subarea of the drive unit. If, for example, the further fluid has a higher temperature than the temperature-control agent when the temperature-control agent and the further fluid flow through the heat exchanger, heat passes, for example, from the further fluid to the temperature-control agent via the heat exchanger such that the temperature-control agent is heated. If, for example, the further fluid has a lower temperature than the temperature-control agent when the temperature-control agent and the further fluid flow through the heat exchanger, heat passes, for example, from the temperature-control agent to the further fluid via the heat exchanger, as a result of which the temperature-control agent is cooled. It is thus, for example, possible to heat the subarea by the temperature-control agent heated by the heat exchanger. It is moreover conceivable to cool the subarea of the drive unit by the temperature-control agent cooled by the heat exchanger.

In order then to be able to control the temperature of the subarea of the drive unit particularly efficiently and particularly effectively, in the method at least one respective associated cooling value, i.e. one belonging to the respective operating point, is calculated by an electronic calculating device in particular on the basis of a calculation model, also referred to as a temperature model, for the respective operating point of the pump. The respective cooling value characterizes a respective temperature which can be effected by the respective operating point, belonging to the respective cooling value, of the pump, in particular a change in temperature and hence controlling of the temperature of the subarea of the drive unit. In other words, a respective temperature, in particular a change in temperature, of the subarea of the drive unit can be effected by in particular theoretical operation of the pump at the respective operating point because, when the pump is operated or if it were operated at the respective operating point, the pump conveys or would convey the temperature-control agent to the subarea and in particular conveys or would convey it through the subarea. As a result, the temperature of the subarea of the drive unit is or would be controlled, and therefore it is or would be cooled or heated, at the respective operating point by the temperature-control agent, which causes or would cause a respective temperature, in particular a change in temperature, of the subarea or of the drive unit, or which accompanies or would accompany, or is to be equated with or corresponds to, a temperature or a change in temperature of the subarea. It is thus in particular provided in the method that the temperature-control agent is conveyed through the flow path, and consequently conveyed to the subarea, by the pump, wherein it is in particular provided that the temperature-control agent is conveyed through the subarea by the pump. Subsequently, an exchange of heat can take place between the temperature-control agent flowing through the subarea and the subarea, as a result of which the temperature of at least the subarea of the drive unit is controlled. If, for example, the temperature-control agent has a lower temperature than the subarea when the temperature-control agent flows through the subarea, the temperature of the subarea can be kept low, and therefore the subarea can be protected from undesired heating, and the change in temperature of the subarea is then cooling of the subarea. If, for example, the temperature-control agent has a higher temperature than the subarea when the temperature-control agent flows through the subarea, the temperature of the subarea can be kept high, and therefore undesired cooling or an undesirably low temperature of the subarea can be avoided, and the change in temperature is then heating of the subarea. The subarea can thus be held at an advantageous temperature or within an advantageous temperature range by the temperature-control agent such that particularly high-performance operation of the drive unit, in particular of the electric machine, can be achieved. In particular, the change in temperature of the subarea is understood to mean a difference between a first temperature and a second temperature of the subarea, wherein, for example, the subarea of the drive unit has the first temperature at a first point in time and/or at a first of the operating points and the second temperature at a second point in time and/or at a second of the operating points such that, for example, the change in temperature results from a change in the operating point of the pump. i.e. results from the pump being operated first at the first operating point and then at a second operating point, or vice versa. In particular, the change in temperature is understood to mean a measure or a strength of the controlling of the temperature of the subarea which is or can be effected by the respective operating point or by the temperature-control agent.

In the method according to the present disclosure, one of the operating points is selected depending on the calculated cooling values by the electronic calculating device, and the pump is operated, in particular regulated, by the electronic calculating device at the selected operating point. For example, one of the calculated cooling values is selected and the pump is operated by the electronic calculating device at the operating point which belongs to the selected cooling value. It is apparent that the calculation of the cooling values is an advance calculation which is performed in order, after the advance calculation has been performed and hence on the basis of the advance calculation, to select one of the operating points and to operate the pump at the selected operating point. Excessively frequent changing of the operating point of the pump can consequently be avoided such that effective temperature control is feasible in a particularly efficient manner.

For example, the flow path is a constituent part of a circuit through which the temperature-control agent can flow and in which are also arranged the heat exchanger, the pump, and at least the subarea of the drive unit, in particular at least a subarea of the electric machine. A tank or reservoir in which the temperature-control agent is or can be held can also be arranged in the circuit.

In order to be able to control the temperature of the subarea and hence the drive unit particularly effectively and particularly efficiently, in one embodiment of the present disclosure it is provided that a target function of an optimization problem is generated by the electronic calculating device depending on the cooling values, the target function of which comprises speeds of the pump at the operating points as parameters or variables of the target function. At least or preferably precisely one extreme value of the target function is determined, in particular calculated, by the electronic calculating device, and the operating point belonging to the determined extreme value is selected by the electronic calculating device. As a result, it is possible, on the one hand, to be able to control the temperature of the subarea particularly effectively, i.e., in particular intensely, and, on the other hand, to operate the pump as efficiently, in particular as energy-efficiently, as possible. The speeds of the pump are understood in particular to mean the following: the pump has, for example, a pump housing and a conveying element arranged in the pump housing. The pump moreover has, for example, a drive, in particular an electric motor. The conveying element can be driven, in particular by the drive, and can consequently be rotated about an axis of rotation relative to the pump housing. By virtue of rotation of the conveying element about the axis of rotation relative to the pump housing, and therefore by virtue of the conveying element being driven, the temperature-control agent can be conveyed by the conveying element and by the pump. For example, the conveying element is rotated at the first operating point about the axis of rotation relative to the pump housing at a first of the speeds, which results, for example, in the first volume flow of the temperature-control agent. The conveying element is, for example, rotated at the second operating point about the axis of rotation relative to the pump housing at a second of the speeds, wherein the second speed differs from the first speed. The second volume flow of the temperature-control agent results, for example, herefrom. The different volume flows at the different operating points thus result from the different speeds of the conveying element, and therefore of the pump. The relevant background is in particular that losses of the pump increase as the speed of the pump rises. It is therefore desirable to keep the speed of the pump as low as possible. Other elements in the drive unit which is also referred to as the drive train or drive device likewise have higher losses because of a higher flow of oil; these losses include, for example, shearing losses in the electric motor gap and gear churning losses. On the other hand, the temperature of the subarea can, for example, be controlled more intensely, i.e. it can be cooled more intensely or heated more intensely, the higher the volume flow with which the temperature-control agent flows through the subarea, wherein the volume flow of the temperature-control agent is higher, the higher the speed of the pump. Determining, in particular calculating, the extreme value of the target function is understood to mean that the target function is minimized or maximized by the electronic calculating device. As a result, it is possible to determine a or the optimum value of the target function with respect to the temperature control of the subarea, and therefore the optimal temperature control of the subarea, such that in particular, on the one hand, the speed of the pump is kept as low as possible and, on the other hand, the temperature of the subarea of the drive unit can be controlled as intensely as possible.

It has been shown to be particularly advantageous here if the target function is the change in temperature of the subarea which can be effected by the operating points, wherein the extreme value is a or the optimum value from the lowest possible speed of the pump and the largest possible change in temperature of the subarea. It is thus possible to control the temperature of the subarea, in particular to cool it, as intensely as possible and to keep the speed of the pump as low as possible such that, on the one hand, particularly effective control of the temperature of the drive unit and, on the other hand, as efficient as possible operation of the pump and hence of the motor vehicle as a whole are feasible.

For example, at least one respective associated temperature value is calculated by the electronic calculating device in particular on the basis of the calculation model for the respective operating point, said temperature value characterizing a respective supply temperature which is also referred to as the outlet temperature or takes the form of an outlet temperature and at which the temperature-control fluid is supplied by the heat exchanger at the respective operating point, in particular flows out of the heat exchanger, for example via an outlet of the heat exchanger, wherein the respective cooling value which belongs to the respective operating point is calculated by the electronic calculating device depending on the respective temperature value belonging to the respective operating point. As a result, the cooling values can be determined particularly accurately such that, on the one hand, the electric machine can be cooled effectively and, on the other hand, the pump can be operated particularly efficiently.

In order to be able to control the temperature of the drive unit particularly effectively, it is provided in a further embodiment of the present disclosure that the electric machine has the said rotor with the said rotor shaft. For example, the electric machine also has the said stator by which the rotor can be driven and consequently can be rotated about an axis of rotation of the machine relative to the stator. As a result, the rotor shaft can be rotated about the axis of rotation of the machine relative to the stator by the rotor being driven. In particular, the electric machine can supply driving torque via its rotor in order to drive the motor vehicle electrically, in particular solely electrically.

It has been shown to be particularly advantageous here, in order to achieve particularly effective control of the temperature of the drive unit, in particular of the electric machine, if at least one longitudinal area of the rotor shaft is used as the subarea. It is in particular conceivable that, by conveying the temperature-control agent, the pump conveys the temperature-control agent through the subarea and hence through the longitudinal area, in particular through the whole rotor shaft, as a result of which the temperature of the electric machine can be controlled effectively.

A further embodiment is characterized in that at least one respective associated second cooling value is calculated by the electronic calculating device in particular on the basis of the calculation model for the respective operating point, said second cooling value characterizing a respective change in temperature, which can be effected by the respective operating point of the pump belonging to the respective second cooling value, of a second subarea of the drive unit, in particular of the electric machine. The explanations above and below relating to the first subarea can also be readily transferred to the second subarea, and vice versa. One of the operating points is selected here by the electronic calculating device depending on the calculated first cooling values and depending on the calculated second cooling values, and the pump is operated at the selected operating point by the electronic calculating device. The background to this embodiment is the dividing of the drive unit, in particular the electric machine, into the subareas and the determination of the respective temperature control, and therefore change in temperature, of the respective subarea which can be effected by the temperature-control agent and hence by the respective operating point. As a result, for example, the temperature of the drive unit can advantageously be controlled both in the first subarea and in the second subarea such that effective temperature control of the drive unit is feasible.

It has been shown to be particularly advantageous here if a first longitudinal area of the rotor shaft is used as the first subarea and a second longitudinal area of the rotor shaft is used as the second subarea. As a result, the temperature of the drive unit, in particular of the electric machine, can be controlled particularly advantageously.

For example, by conveying the temperature-control agent, the temperature-control agent is conveyed through the first subarea and through the second subarea such that a particularly advantageous exchange of heat between the temperature-control agent and the subarea is feasible.

In a further particularly advantageous embodiment of the present disclosure, a liquid, in particular an oil, is used as the temperature-control agent, as a result of which the temperature of the drive unit can be controlled particularly advantageously.

Lastly, it has been shown to be particularly advantageous, in order to achieve particularly advantageous control of the temperature of the temperature-control agent, if a liquid is used as the further fluid. For example, the liquid is or comprises water at least partially, in particular at least predominantly, such that a particularly advantageous exchange of heat between the temperature-control agent and the further fluid is feasible.

It is in particular conceivable that the pump, which for example takes the form of an oil pump, and hence the circuit, which for example takes the form of an oil circuit, can be controlled or regulated at least almost freely in particular by the electronic calculating device. The volume flow and thus a quantity of the temperature-control agent which is conveyed by the pump, flows through the flow path and in particular the circuit, and is also referred to as the flow rate or oil flow rate, is virtually equivalent to the speed of the pump, also referred to as the pump speed. In particular, the pump, in particular its drive, can, for example, be regulated or controlled by the electronic calculating device which is also referred to as a controller or takes the form of a controller. For example, the electronic calculating device comprises the thermal model (calculation model) which is stored, for example, in an in particular electrical or electronic store, in particular a data store, of the electronic calculating device. For example, at least one or more temperature sensors are provided, wherein a respective temperature of the temperature-control agent can be or is detected by the respective temperature sensor. Alternatively or additionally, the respective temperature can be modeled, i.e. be calculated by a calculation model. The respective temperature of the temperature-control agent is used, for example, as an input variable to or for the thermal model such that, for example, the electronic calculating device calculates the respective cooling value and/or the respective temperature value on the basis of the thermal model depending on the respective detected temperature of the temperature-control agent.

It is usually provided that the electronic calculating device calculates a quantity of the temperature-control agent which is to be conveyed by the pump on the basis of the calculation model and depending on the respective detected temperature of the temperature-control agent and, for example, depending on at least one or more further model variables, and activates the pump depending on the calculated quantity of the temperature-control agent which is to be conveyed by the pump, and consequently, for example, sets the speed of the pump in such a way that the pump conveys, i.e. supplies, the calculated quantity of the temperature-control agent. If, for example, the temperature of the subarea, in particular of the electric machine and very particularly of the rotor, then rises, the pump is activated, in particular usually above a threshold temperature, in such a way that the speed of the pump and thus the quantity of the temperature-control agent or its volume flow rise such that the subarea can subsequently emit heat to the temperature-control agent. The rotor shaft can have a similar design to a tube or be considered as a tube, wherein the temperature-control agent is conveyed into the rotor shaft, for example, by the pump via an inlet opening and conveyed out of the rotor shaft via an outlet opening. The temperature-control agent can therefore flow into the rotor shaft via the inlet opening and flow out via the rotor shaft via the outlet opening. For example, the inlet opening is arranged at a first axial end side of the rotor shaft. For example, the outlet opening is arranged at a second axial end side of the rotor shaft, the second axial end side of which is remote from the first axial end side in the axial direction of the rotor shaft. It is moreover conceivable that the temperature-control agent flows into the rotor shaft in the axial direction of the rotor shaft or in the radial direction of the rotor shaft and/or the temperature-control agent can flow out of the rotor shaft in the axial direction of the rotor shaft or in the radial direction of the rotor shaft. Because of a possible temperature difference between the temperature-control agent and the rotor shaft or the subarea, heat exchange occurs between the temperature-control agent flowing through the subarea and the subarea, as a result of which the temperature of the subarea is controlled, i.e. it is cooled or heated. The temperature difference is also designated by dT. The heat exchange between the temperature-control agent flowing through the subarea and the subarea (rotor shaft) takes place, for example, according to the principle of in particular forced convection.

The following explanations relate in particular to cooling of the subarea by the temperature-control agent. The higher the velocity, also referred to as the liquid velocity, at which the temperature-control agent flows through the subarea, the greater the heat that the temperature-control agent can in particular absorb from the subarea per unit time when the temperature-control agent is provided for cooling the subarea and therefore takes the form of or functions as a coolant. It is then, for example, provided that the temperature-control agent is cooled by the heat exchanger. An outlet temperature at which the temperature-control agent flows out of the subarea is, however, lower at higher velocities of the temperature-control agent than at relatively lower velocities at which the temperature-control agent flows through the subarea when the subarea needs to be or is cooled by the temperature-control agent. For example, at an assumed constant velocity of the temperature-control agent flowing through the subarea and at an assumed constant inlet temperature at which the temperature-control agent flows into the subarea, heat exchange takes place between the temperature-control agent flowing through the subarea and the subarea depending on the velocity at which the temperature-control agent flows through the subarea, and depending on an exchange surface area over which the heat exchange can take place between the temperature-control agent flowing through the subarea and the subarea. The lower the velocity at which the temperature-control agent flows through the subarea, the higher the outlet temperature at which the temperature-control agent flows out of the subarea (large temperature difference between an inlet temperature at which the temperature-control agent flows into the subarea and the outlet temperature). The higher the velocity, also referred to as the flow velocity, at which the temperature-control agent flows through the subarea, the higher an outlet velocity at which the temperature-control agent flows out of the subarea. The higher the velocity at which the temperature-control agent flows through the subarea, the lower the outlet temperature at which the temperature-control agent flows out of the subarea (small temperature difference between the outlet temperature and the inlet temperature).

The problem exists in conventional solutions that, when there is a need for temperature control, in particular cooling, of the subarea, in particular of the electric machine, or when this need increases, the pump is operated, in particular regulated, such that a high or a higher volume flow is created in the flow path and thus in particular in the circuit and in the subarea, as a result of which the subarea can advantageously emit heat to the temperature-control agent or can absorb heat from the temperature-control agent. The high flow velocity of the temperature-control agent generates, for example, at an assumed constant temperature in the reservoir, a low temperature difference between a heat exchanger inlet temperature at which the temperature-control agent flows into the heat exchanger and a heat exchanger outlet temperature at which the temperature-control agent flows out of the heat exchanger. In particular when the temperature-control agent is or comprises an oil or the further fluid is or comprises water, the heat exchanger is a so-called oil-to-water heat exchanger. A small temperature difference between the heat exchanger inlet temperature and the heat exchanger outlet temperature results in a relatively high temperature at which the temperature-control agent flows into the subarea, in particular into the rotor shaft, which can result in a temperature-control performance, in particular cooling performance, that is only low in the subarea compared with a lower heat exchanger outlet temperature or compared with a larger difference between the heat exchanger outlet temperature and the heat exchanger inlet temperature. In other words, the higher the velocity at which the temperature-control agent flows through the subarea, the greater the heat that is transported away from the subarea per unit time by the temperature-control agent (in the case of cooling of the subarea) or the greater the heat that is transmitted to the subarea per unit time by the temperature-control agent (in the case of heating of the subarea), but the higher the velocity at which the temperature-control agent flows through the subarea and thus through the flow path and through the heat exchanger, the higher the heat exchanger outlet temperature of the temperature-control agent which, for example, flows out of the heat exchanger at the heat exchanger outlet temperature (in the case of cooling of the temperature-control agent by the heat exchanger), wherein, for example, the temperature-control agent flows into the subarea at the heat exchanger outlet temperature. In other words, a temperature such as, for example, the abovementioned inlet temperature at which the temperature-control agent flows into the subarea is higher, the higher the heat exchanger outlet temperature at which the temperature-control agent flows out of the heat exchanger. There is thus a conflict of aims between the desire to convey the temperature-control agent through the flow path and thus through the heat exchanger and the subarea with a lower volume flow or at a lower velocity, in order to achieve a low heat exchanger outlet temperature, and the desire to convey the temperature-control agent through the subarea with a high volume flow or at a high velocity, in order to discharge a high quantity of heat from the subarea or feed it into the subarea per unit time. There is thus a conflict of aims between the desire to operate the pump at a low speed and the desire to operate the pump at a high speed because a high volume flow or a high velocity of the temperature-control agent can be effected by a high speed of the pump, and a low volume flow or a low velocity of the temperature-control agent can be effected by a relatively lower or low speed of the pump. A lower velocity at which the temperature-control agent flows through the heat exchanger is in particular desirable because the temperature of the temperature-control agent can then be intensely controlled, in particular it can be cooled, on its course through the heat exchanger by the further fluid.

The above-described conflict of aims can now be resolved by the method according to the present disclosure. The method according to the present disclosure namely makes it possible to achieve an optimum value from the largest possible or most intense possible temperature control, in particular cooling, of the subarea and the smallest possible or lowest possible speed of the pump, and therefore the smallest possible or lowest possible velocity of the temperature-control agent. The temperature-control agent can consequently be supplied, for example, by the heat exchanger at a particularly advantageously low heat exchanger outlet temperature in order to cool the subarea such that the temperature-control agent can subsequently flow into the subarea at an advantageously lower temperature and, on the other hand, the temperature-control agent can be conveyed through the subarea advantageously quickly, i.e. at an advantageously high velocity, such that, for example, a high quantity of heat can be transported away from the subarea by the coolant per unit time when the subarea is being cooled or in order to cool it.

Further details of the present disclosure can be found in the following description of a preferred exemplary embodiment with the associated drawings.

### BRIEF DESCRIPTION OF THE DRAWINGS

FIG. 1 shows a schematic illustration of an electric machine of a drive unit of a motor vehicle, the electric machine of which is temperature-controlled, i.e. cooled or heated; and

FIG. 2 shows a schematic view in longitudinal area of a rotor shaft of the electric machine.

### DETAILED DESCRIPTION OF THE DRAWINGS

The same or functionally similar elements are provided with the same reference signs in the Figures.

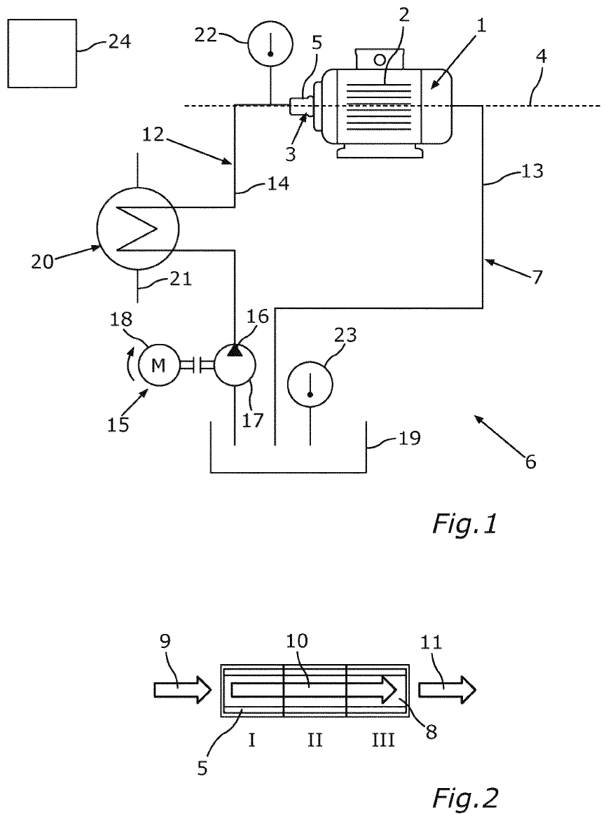

A method for controlling the temperature of at least one subarea of an electric drive unit of a motor vehicle, also referred to as a vehicle, i.e. for cooling and/or heating it, is explained below on the basis of FIGS. 1 and 2. The drive unit here has at least one electric machine 1. The motor vehicle can be driven electrically, in particularly solely electrically, by the electric machine 1. It is thus conceivable that in the method the motor vehicle is driven electrically, in particular solely electrically, by the electric machine 1. The electric machine 1 has a stator 2 and a rotor 3 which can be driven by the stator 2 and consequently can be rotated about an axis of rotation 4 of the machine relative to the stator 2. The rotor 3 has a rotor shaft 5 which can be driven by the described driving of the rotor 3 and consequently can be rotated about the axis of rotation 4 of the machine relative to the stator 2. The electric machine 1 can supply driving torque via its rotor shaft 5 in order to drive the motor vehicle electrically, in particular solely electrically.

The said subarea of the drive unit, the temperature of which is to be controlled, is or comprises at least a part or subarea of the electric machine 1 such that, in the method, the temperature of the electric machine 1, i.e. at least the subarea of the electric machine, is controlled. In the method, the temperature of the electric machine 1 is controlled by a temperature-control device 6. The temperature-control device 6 comprises a circuit 7 through which a temperature-control agent can flow. It is in particular provided that, in the method, the temperature-control agent flows through the circuit 7. In the exemplary embodiment shown in the Figures, the temperature-control agent is a liquid, in particular an oil, such that, when oil is referred to below, the oil is to be understood as the temperature-control agent. The method is described below on the basis of controlling the temperature, in the form of cooling, the electric machine 1 such that, in the method according to the exemplary embodiment shown in the Figures, the electric machine 1 is cooled by the oil. In particular, in the method, at least the rotor shaft 5 of the electric machine 1 is cooled by the oil, which can be seen, for example, in FIG. 2. The rotor shaft 5 has inside it an in particular central temperature-control channel 8 which in the present case is in the form of a cooling channel or functions as a cooling channel and which is also referred to as simply a channel and through which the temperature-control agent flows or can flow. The channel and thus the rotor shaft 5 are thus, for example, arranged in the circuit. In FIG. 2, arrows 9, 10, and 11 illustrate the temperature-control agent, flowing through the circuit 7 and thus the rotor shaft 5, by which the temperature of the rotor shaft 5 is controlled, in the present case by which it is cooled. In particular, the arrow 9 illustrates that the temperature-control agent flows, for example, into the channel and thus into the rotor shaft 5, in particular via an inlet opening of the channel or of the rotor shaft 5, at an inlet temperature which is also referred to as the shaft inlet temperature. The arrow 11 illustrates, for example, that the temperature-control agent flows, for example, out of the rotor shaft 5 or out of the channel, in particular via an outlet opening of the channel or the rotor shaft 5, in particular at an outlet temperature which is also referred to as the shaft outlet temperature. The arrow 10 illustrates that the temperature-control agent flows through the channel and thus through the rotor shaft 5, in particular from the inlet opening to the outlet opening. When the rotor shaft 5 is cooled as described above, the temperature-control agent is heated on its course through the channel from the inlet opening to the outlet opening such that, when the rotor shaft 5 is cooled. also referred to as the cooling scenario, the shaft outlet temperature is greater than the shaft inlet temperature, and therefore the temperature-control agent is heated on its course through the channel from the inlet opening to the outlet opening. As a result, the rotor shaft 5 is cooled. A difference between the shaft outlet temperature and the shaft inlet temperature of the temperature-control agent, also referred to as the difference or temperature difference, characterizes, for example, a strength, measure, or degree of the temperature control of the rotor shaft 5, the temperature control of which in the exemplary embodiment shown in the Figures takes the form of cooling of the rotor shaft 5 and thus the electric machine 1. In particular, for example, the difference between the shaft outlet temperature and the shaft inlet temperature characterizes or describes a change in temperature of the rotor shaft 5 which is effected by the cooling of the rotor shaft 5 and thus by the temperature-control agent flowing through the rotor shaft 5, wherein, because the rotor shaft 5 is cooled in the exemplary embodiment shown in the Figures, the change in temperature is a reduction in temperature of the rotor shaft 5.

Longitudinal areas of the rotor shaft 5 are designated by I, II, and III in FIG. 2. It can be seen that the longitudinal areas I and III are subareas of the rotor shaft 5 and thus the electric machine 1, wherein the longitudinal areas I, II, and III succeed one another in the axial direction of the rotor shaft 5, the axial direction of which coincides with the axis of rotation 4 of the machine, and therefore are arranged successively. For example, the abovementioned subarea of the electric machine 1 is the longitudinal area I, wherein the longitudinal areas II and III are further subareas of the electric machine 1.

It can be seen in FIG. 1 that the channel (temperature-control channel 8) and thus the rotor shaft 5 and the electric machine 1 are arranged in the circuit 7. Because the rotor shaft 5 is cooled in the exemplary embodiment shown in the Figures, the circuit 7 is a cooling circuit or the circuit 7 functions or works as a cooling circuit. The circuit 7 comprises a feed line 12 and a return line 13. Also arranged in the circuit 7 is a tank 19 which is also referred to as a reservoir. The oil which in the present case is in the form of oil and functions as a coolant can be held, and therefore stored, at least temporarily in the tank 19, in particular with the formation of a transmission or oil sump which is also referred to as a sump. The oil can be routed via the feed line 12 from the tank 19 to the rotor shaft 5 and to the channel (temperature-control channel 8). The oil can thus flow out of the temperature-control channel 8 via the outlet opening and subsequently flow into the return line 13 and is routed back to and into the tank 19 by the return line 13. The oil which flows through the feed line 12 can flow out of the feed line 12 and subsequently flow through the inlet opening and thus flow into the channel via the inlet opening and subsequently flow through the channel and thus flow from the inlet opening to the outlet opening. Part of the feed line 12 is a flow path 14 through which the oil can flow or through which the oil flows. The oil thus flows through the flow path 14 on its course from the tank 19 to the channel.

The temperature-control device 6 also comprises a pump 15, arranged in particular in the circuit 7, in particular in the feed line 12, by which, in the method, the oil is conveyed through the circuit 7 and thus through the temperature-control channel 8, the feed line 12, and the return line 13. Because the temperature-control agent is an oil in the exemplary embodiment shown in the Figures, the pump 15 is also referred to as an oil pump. In the exemplary embodiment shown in the Figures, the pump 15 takes the form of an electric pump. The pump 15 has a conveying element 16, illustrated particularly schematically in FIG. 1, and a pump housing 17. The pump 15 moreover has a drive 18, which in the present case takes the form of an electric motor and is also referred to as a motor, by which the conveying element 16 can be driven and consequently can rotate or is rotated about an axis of rotation relative to the pump housing 17. By virtue of rotation of the conveying element 16, the oil is conveyed by the conveying element 16 and thus by the pump 15, and to be precise through the circuit 7.

The pump 15 can be operated at different operating points, wherein the operating points differ from one another in terms of a respective speed at which the conveying element 16 is rotated by the drive 18 about the axis of rotation relative to the pump housing 17. In other words, the conveying element 16 can be rotated by the drive 18 about the axis of rotation relative to the pump housing 17 at different speeds. This means, for example, that the drive 18 drives the conveying element 16 at a first of the operating points in such a way that the conveying element 16 is rotated about the axis of rotation relative to the pump housing 17 at a first of the speeds such that the conveying element 16 rotates about the axis of rotation relative to the pump housing 17 at the first speed at the first operating speed, or that the conveying element 16 has the first speed at the first operating point. At a second of the operating points, the drive 18 drives, for example, the conveying element 16 in such a way that the conveying element 16 is rotated about the axis of rotation relative to the pump housing 17 at a second speed. Thus the conveying element 16 rotates about the axis of rotation relative to the pump housing 17 at the second speed at the second operating point, or the conveying element 16 has the second speed at the second operating point. The first speed and the second speed thus differ from each other such that, for example, the second speed is greater than or less than the first speed. A respective volume flow of the oil, which flows with the volume flow through the circuit 7 and thus through the temperature-control channel 8, i.e. the rotor shaft 5, is effected by the respective speed of the conveying element 16. This means, for example, that the oil flows with a first of the volume flows through the circuit 7 and thus through the temperature-control channel 8 at the first operating point, wherein the oil flows with a second of the volume flows through the circuit 7 and thus through the temperature-control channel 8 at the second operating point, wherein the first volume flow and the second volume flow differ from each other. In other words, the second volume flow is greater or smaller than the first volume flow. Put in still other words, the first volume flow of the oil flows at the first operating point and the second volume flow of the oil, which differs from the first volume flow, flows through the circuit 7 and thus through the temperature-control channel 8 at the second operating point. The volume flow of the oil is thus greater, the greater the speed of the conveying element 16. Thus, if, for example, the second speed is greater than the first speed, the second volume flow of the oil effected by the second speed is greater than the first volume flow of the oil effected by the first speed. It is apparent that the pump 15 can thus be operated with different volume flows of the oil at the different operating points.

The temperature-control device 6 moreover has a heat exchanger 20, arranged in the flow path 14 upstream from the electric machine 1, in particular upstream from the rotor shaft 5 and very particularly upstream from temperature-control channel 8, and downstream from the pump 15, through which the oil can thus flow. This means that the oil flows through the heat exchanger 20 on its course through the flow path 14 from the pump 15 to the rotor shaft 5, i.e. to the temperature-control channel 8. The heat exchanger 20 is moreover arranged in a fluid circuit 21 which is illustrated particularly schematically in FIG. 1 and provided in addition to the circuit 7 and through which a further fluid can flow or flows. The oil is a first liquid, wherein the fluid is preferably a second liquid. For example, the further fluid is or comprises at least partially, in particular at least predominantly, water. Because the heat exchanger 20 is arranged both in the circuit 7 and in the fluid circuit 21, both the oil and the further fluid can flow through the heat exchanger 20. In particular, it is provided in the method that both the oil and the further fluid flow through the heat exchanger 20. By the heat exchanger 20, heat can be exchanged between the oil flowing through the heat exchanger 20 and the further fluid flowing through the heat exchanger 20 such that by the heat exchanger 20 the temperature of the oil flowing through the heat exchanger 20 can be controlled, i.e. in order to cool or heat it, in particular is controlled, by the further fluid flowing through the heat exchanger 20. Because the rotor shaft 5 is cooled by the oil in the exemplary embodiment shown in the Figures, in the exemplary embodiment shown in the Figures the oil flowing through the heat exchanger 20 is cooled via the further fluid flowing through the heat exchanger 20 by the heat exchanger 20. This takes place in such a way that heat passes from the oil flowing through the heat exchanger 20, via the heat exchanger 20, to the further fluid flowing through the heat exchanger 20. Because both the oil and the further fluid are a respective liquid, wherein the second fluid preferably is or comprises water, the heat exchanger 20 is also referred to as an oil-to-water heat exchanger. After the oil has flowed through the temperature-control channel 8 and the temperature of the rotor shaft 5 has thus been controlled, in the present case after it has been cooled, the oil is routed by the return line 13 from the temperature-control channel 8 and thus from the rotor shaft 5 back into the tank 19.

The temperature-control device 6 comprises a first sensor 22 which takes the form of a first temperature sensor. A temperature of the oil flowing through the flow path 14 is detected by the sensor 22 in particular downstream from the heat exchanger 20 and upstream from the temperature-control channel 8 or the rotor shaft 5. The temperature which is detected by the sensor 22 is also referred to as the first temperature. The first temperature is, for example, the shaft inlet temperature. It is apparent that the oil has the first temperature in the circuit 7, in particular the flow path 14, downstream from the heat exchanger 20 and, for example, upstream from the temperature-control channel 8. Alternatively or additionally, the temperature-control device 6 has a second sensor 23 which takes the form of, for example, a second temperature sensor. A second temperature of the oil in the tank 19 is, for example, detected by the sensor 23 such that, for example, the oil has the second temperature in the tank 19. It is moreover conceivable to model at least one of the temperatures, i.e. to calculate it by a calculation model.

The temperature-control device 6 furthermore comprises an electronic calculating device 24, illustrated particularly schematically in FIG. 1, which is also referred to as a controller. In the method, the electronic calculating device 24 activates the pump 15, in particular the drive 18, as a result of which, for example, the pump 15 is controlled or regulated. In other words, it is provided in the method that the pump 15, in particular the drive 18, is operated, i.e. controlled or regulated, by the controller. In particular, it is provided when operating the pump 15 that the controller can set or sets the different operating points and thus the different speeds of the pump 15.

The following conflict of aims now usually exists: on the one hand, it is desirable that the oil flows through the temperature-control channel 8 and thus through the rotor shaft 5 as quickly as possible and thus with the highest possible volume flow such that a large quantity of heat can be transported away from the rotor shaft by the oil per unit time in order to cool the rotor shaft 5. On the other hand, it is desirable that the oil flows through the heat exchanger 20 as slowly as possible and thus with the lowest possible volume flow such that the oil is cooled as intensely as possible by the heat exchanger 20. For example, the oil flows into the heat exchanger 20, in particular via an inlet of the heat exchanger 20, at a heat exchanger inlet temperature, and, for example, the oil flows out of the heat exchanger 20, in particular via an outlet of the heat exchanger 20, at a heat exchanger outlet temperature. For example, the first temperature of the oil is the heat exchanger outlet temperature, or the first temperature results from the heat exchanger outlet temperature. Thus, for example, the oil has the heat exchanger inlet temperature upstream of the heat exchanger 20 and in particular downstream of the pump 15 and, for example, the oil has the heat exchanger outlet temperature downstream of the heat exchanger 20 and in particular upstream of the temperature-control channel 8 such that, for example, the heat exchanger 20 supplies the oil at the heat exchanger outlet temperature. The heat exchanger outlet temperature is therefore also referred to as the supply temperature. Because, in the exemplary embodiment shown in the Figures, the oil is cooled by the heat exchanger 20, the heat exchanger outlet temperature is lower than the heat exchanger inlet temperature of the oil. A difference, also referred to as a temperature difference, between the heat exchanger outlet temperature and the heat exchanger inlet temperature of the oil is, characterizes, or describes a strength, a measure, or a degree of temperature control of the oil effected or which can be effected by the heat exchanger 20, wherein because the oil is cooled by the heat exchanger 20 in the exemplary embodiment shown in the Figures, the temperature control of the oil effected or which can be effected by the heat exchanger 20 is cooling of the oil. The lower the heat exchanger outlet temperature or the difference between the heat exchanger outlet temperature and the heat exchanger inlet temperature, the more intensely the oil is cooled by the heat exchanger 20. The greater the difference between the shaft outlet temperature and the shaft inlet temperature or the higher the shaft outlet temperature, the more intensely the rotor shaft 5 is cooled by the oil. With respect to the cooling of the oil effected or which can be effected by the heat exchanger 20, it is desirable that the oil flows through the heat exchanger 20 as slowly as possible, i.e. with the lowest possible volume flow, in order as a result to obtain as low as possible a heat exchanger outlet temperature or as large as possible a difference between the heat exchanger outlet temperature and the heat exchanger inlet temperature of the oil. The conflict of aims thus exists in particular of, on the one hand, trying to achieve as high as possible a speed of the conveying element 16 in order to effect as large as possible a volume flow of the oil through the rotor shaft 5 and, on the other hand, setting as low as possible a speed of the conveying element 16 in order as a result to effect or set as low as possible a volume flow of the oil through the heat exchanger 20. A further advantage of as low as possible a speed of the conveying element 16 and thus the pump 15 is that, as the speed of the pump 15 increases, losses of the pump 15 and other elements in the flow of oil increase such that losses of the pump 15 can advantageously be kept low by virtue of a low speed of the pump 15.

The abovementioned method can resolve or address the conflict of aims such that the temperature of the electric machine 1 can be controlled, in the present case it can be cooled, by the method particularly effectively and particularly efficiently. By the electronic calculating device 24, at least one respective associated cooling value is calculated on the basis of a calculation model for the respective settable operating point of the pump 15 which is also referred to as a thermal model and is stored, for example, in a data store of the electronic calculating device 24, said cooling value characterizing, i.e. describing or specifying, a respective temperature of the rotor shaft 5 which can be effected by the respective operating point, belonging to the respective cooling value, of the pump 15. Because, in the exemplary embodiment shown in the Figures, the rotor shaft 5 is divided into the longitudinal areas I, I, and III which are also referred to as portions and can thus be considered in terms of longitudinal areas or in terms of portions, at least one respective associated cooling value is, for example, calculated by the electronic calculating device 24 on the basis of the calculation model for the respective operating point and for the respective longitudinal area I, II, III, said cooling value characterizing a respective temperature of the respective longitudinal area I, II, III which can be effected by the respective operating point, belonging to the respective cooling value, of the pump 15. Thus, for example, first of the cooling values characterize first temperatures of the first longitudinal area I, wherein the first temperatures can be effected, i.e. set, by the operating points and thus the associated volume flows. Accordingly, for example, second of the cooling values characterize second temperatures of the second longitudinal area II, wherein, for example, the second temperatures can be effected, i.e. set, by the operating points of the pump 15 and thus the associated volume flows. Accordingly, for example, third of the cooling values characterize third temperatures of the third longitudinal area III, wherein the third temperatures can be set, i.e. effected, by the operating points of the pump 15 and thus by the associated volume flows. The calculation of the cooling values is an advance calculation because the advance calculation is performed, and therefore the cooling values calculated, before one of the operating points is set, i.e. before, for example, the pump 15 is transferred from one of the operating points into another of the operating points. Advance regulation or advance control can be implemented as a result.

One of the operating points is selected depending on the calculated cooling values by the electronic calculating device 24. The pump 15 is then activated by the electronic calculating device 24, as a result of which the pump 15 is operated at the selected operating point.

For example, the respective cooling value characterizes or describes a respective change in temperature, which can be effected by the respective associated operating point and thus the respective associated volume flow, of the respective longitudinal area I, II, III. Because the rotor shaft 5 is cooled in the exemplary embodiment shown in the Figures, the change in temperature is a reduction in temperature, and therefore cooling of the respective longitudinal area I, II, III. For example, a target function of an optimization problem is generated by the electronic calculating device 24 depending on the cooling values, the target function of which comprises the speeds of the pump 15, belonging to the operating points, as parameters. This means that the speeds of the pump 15 are parameters, i.e. variables of the target function. At least or precisely one extreme value of the target function is determined by the electronic calculating device 24, and the operating point belonging to the determined extreme value is selected by the electronic calculating device 24. In particular, the target function is the temperature of the respective longitudinal area I, II, III which can be effected by the operating points, wherein the extreme value is an optimum value from the smallest possible speed and the smallest possible or largest possible temperature of the respective longitudinal area I, II, III. Because the controlling of the temperature of the rotor shaft 5 is cooling of the rotor shaft 5 in the exemplary embodiment shown in the Figures, the extreme value is an optimum value from the smallest possible speed and the lowest possible temperature of the respective longitudinal area I, II, III such that the target function is minimized in the exemplary embodiment shown in the Figures. As a result, the most intense possible cooling of the rotor shaft 5 at the lowest possible speed of the pump 15, and therefore the smallest possible losses of the pump 15 and with the largest possible difference between the heat exchanger outlet temperature and the heat exchanger inlet temperature can be implemented such that optimal cooling, or the optimal cooling, of the rotor shaft 5 can be implemented with respect to the optimization problem.

If, for example, the temperature control of the rotor shaft 5 is heating of the rotor shaft 5 which can be heated in particular by the fact that the oil flowing through the rotor shaft 5 has a higher temperature than the rotor shaft 5, the extreme value is, for example, a or the optimum value from the smallest possible speed and the highest possible temperature of the respective longitudinal area I, II, III. If the rotor shaft 5 is heated by the oil, it is, for example, provided that the oil is heated by the heat exchanger 20. It is desirable here that the heat exchanger outlet temperature, which is then higher than the heat exchanger inlet temperature, is as high as possible such that as large as possible a difference between the heat exchanger outlet temperature and the heat exchanger inlet temperature is then also desirable. The target function is then, for example, maximized such that optimal heating, or the optimal heating, of the rotor shaft 5 is feasible with respect to the optimization problem. On the one hand, the oil can be heated advantageously intensely by the heat exchanger 20 such that the oil flows into the rotor shaft 5 at an advantageously high shaft inlet temperature. On the other hand, the oil can be conveyed through the rotor shaft 5 advantageously quickly, i.e. with an advantageously high volume flow, such that a large quantity of heat can be fed into the rotor shaft 5 per unit time by the oil, i.e. can be transmitted to the rotor shaft 5.

It is apparent that the method enables particularly effective and particularly efficient temperature control of the rotor shaft 5.

For example, the different longitudinal areas I, II, and III of the rotor shaft 5 are mapped in or by the calculation model such that it is possible to selectively set for the longitudinal areas I, II, and III optimal temperature control, in particular cooling, of the respective longitudinal area I, II, III. Weighting or prioritization of the longitudinal areas I, II, III can be provided here, for example in such a way that, for example, the temperature of the first longitudinal area I can be optimally controlled, in particular it can be optimally cooled, by selecting an operating point belonging to the first cooling values, the temperature of the longitudinal area II can be optimally controlled, in particular it can be optimally cooled, by selecting an operating point belonging to the second cooling values, and the temperature of the longitudinal area III can be optimally controlled, in particular it can be optimally cooled, by selecting an operating point belonging to the third cooling values, with respect to the optimization problem.

The method can, for example, alternatively or additionally be used to heat the oil and thus the subarea in a targeted fashion and to resolve the conflict of aims (slowly through the rotor shaft 5 and quickly through the heat exchanger 20) by the targeted heating of the oil, for example in the case of a cold start. Thus, for example, the temperature of the oil can be quickly controlled in order to minimize, for example, churning losses.

### LIST OF REFERENCE SIGNS

1 electric machine
2 stator
3 rotor
4 axis of rotation of the machine
5 rotor shaft
6 temperature-control device
7 circuit
8 temperature-control channel
9 arrow
10 arrow
11 arrow
12 feed line
13 return line
14 flow path
15 pump
16 conveying element
17 pump housing
18 drive
19 tank
20 heat exchanger
21 fluid circuit
22 first sensor
23 second sensor
24 electronic calculating device

1-10. (canceled)

11. A method for controlling a temperature of an electric drive unit comprising at least one electric machine of a motor vehicle, the method comprising:
conveying a temperature-control agent through a flow path by a pump, wherein the temperature of at least a subarea of the drive unit is controlled by the temperature-control agent, and wherein the pump can be operated at different operating points with different volume flows of the temperature-control agent;
conveying the temperature-control agent through a heat exchanger arranged in the flow path upstream of the subarea of the drive unit by the pump and flowing through the flow path, and conveying a further fluid through the heat exchanger;
exchanging heat between the temperature-control agent and the further fluid via the heat exchanger, thereby controlling a temperature of the temperature-control agent;
calculating, by an electronic calculating device, at least one respective associated cooling value for the respective operating point, wherein the cooling value characterizes a respective temperature of the subarea of the drive unit which can be effected by the respective operating point of the pump belonging to the respective cooling value;
selecting, by the electronic calculating device, one of the operating points depending on the calculated at least one respective associated cooling value; and
operating, by the electronic calculating device, the pump at the selected operating point.

12. The method according to claim 11, comprising:
generating, by the electronic calculating device, a target function of an optimization problem depending on the cooling values, wherein the target function comprises speeds of the pump at the operating points as parameters of the target function;
determining, by the electronic calculating device, at least one extreme value of the target function; and
selecting, by the electronic calculating device, the operating point belonging to the determined extreme value.

13. The method according to claim 12,
wherein the target function is the temperature of the subarea that can be effected by the operating points, wherein the extreme value is an optimum value from a smallest possible speed and a smallest possible or a largest possible temperature.

14. The method according to claim 11, comprising:
calculating, by the electronic calculating device, at least one respective associated temperature value for the respective operating point, wherein the temperature value characterizes a respective supply temperature at which the temperature-control agent is supplied by the heat exchanger at the respective operating point, wherein the respective cooling value that belongs to the respective operating point is calculated by the electronic calculating device from the respective temperature value belonging to the respective operating point.

15. The method according to claim II,
wherein the electric machine comprises a rotor with a rotor shaft.

16. The method according to claim 15, comprising:
using at least one longitudinal area of the rotor shaft as the subarea.

17. The method according to claim 11, comprising:
calculating, by the electronic calculating device, at least one respective associated second cooling value for the respective operating point, wherein the second cooling value characterizes a respective change in temperature that can be effected by the respective operating point of the pump belonging to the respective second cooling value of a second subarea of the drive unit;
selecting, by the electronic calculating device, one of the operating points depending on the calculated first cooling values and depending on the calculated second cooling values; and
operating, by the electronic calculating device, the pump at the selected operating point.

18. The method according to claim 17, comprising:
using a first longitudinal area of a rotor shaft as a first subarea, and using a second longitudinal area of the rotor shaft as the second subarea.

19. The method according to claim 11, comprising:
using a liquid as the temperature-control agent.

20. The method according to claim 11, comprising:
using a liquid as the further fluid.
